(19) United States
(12) Patent Application Publication
(10) Pub. No.: US 2005/0281184 A1
(43) Pub. Date: Dec. 22, 2005

(54) Image forming apparatus and associated method

(75) Inventors: Satoshi Sakata, Tokyo (JP); Utami Soma, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/050,751

(22) Filed: Feb. 7, 2005

(30) Foreign Application Priority Data
Jun. 17, 2004 (JP) JP2004-179154

(51) Int. Cl. G11B 5/09

(52) U.S. Cl. 369/275.3; 369/47.1

(57) ABSTRACT

Disclosed is an image forming apparatus comprises an attaching section 63 used to attach register mark information 61 which can be read by a cutting machine on image information 60, where the register mark has a specified shape, size and position. When a printing range of the image information 60 with the register mark exceeds a printing output range representing a size of page memory 64 or a recording medium size, a warning is given to discontinue printing. Thus, erroneous reading of the register mark by the cutting machine is prevented, defective output of a recording medium from the cutting machine is reduced and printing efficiency is improved.

### BACKGROUND OF THE INVENTION

1. Field of the Invention

The present invention relates to an image forming apparatus for printing image information where a cutting mark is printed on the recording medium.

2. Related Art

In recent years, image forming apparatuses may print a cutting mark on a recording medium in addition to image information to be printed. The cutting mark identifies a cutting position and makes it easy for the cutting machine to cut the recording medium after printing, thereby improving work efficiency.

Owing to recent progress of an image recognition technology, the cutting machine reads the mark for cutting on a recording medium, and cuts the recording medium automatically based on the position of the read cutting mark. To read the mark, the cutting machine requires the cutting mark to have a definite form that is peculiar to the cutting machine, and conducts cutting at the position thus read. For instance, the cutting mark is received by the image forming apparatus from a personal computer or PC, together with the image information, under the condition that the cutting mark is combined in image information. One such cutting machine is described for example, in Japanese Non-Examined Patent Publication No. 2002-292831. However, in the aforesaid related art, erroneous cutting is caused when a recording medium is cut by the cutting machine. Namely, erroneous reading is caused when a cutting mark which the cutting machine can read is not compatible with a cutting mark printed on the recording medium.

When the cutting machine makes an erroneous reading, in particular, the output recording medium may be defective because the cutting position may be different from the targeted position. This defective output causes wastefulness of recording media and reduction of printing efficiency. Such systems also do not allow an operator to make changes easily, and thus causes improvement of defective output to be time-consuming, because the cutting mark is attached to the image information input to the image forming apparatus.

Apart from the above mentioned reason, to print the image information and the cutting marks on a recording medium, the printing area including the image information and the cutting marks will be larger than the original area of the image information. The printing area may exceed to the area of recording medium; therefore, there is a possibility that a defective output is produced by the cutting machine because the cutting marks may not be able to be printed on the recording medium.

For the above reasons, an image forming apparatus, method and system that can prevent the cutting machine from generating defective cutting output.

The invention is one to be achieved to solve the problems in the related art, and its object is to provide an image forming apparatus, method and system that can produce printing outputs that can prevent the cutting machine from generating a defective cutting output.

### SUMMARY

Consistent with embodiments of the present invention, systems, methods and computer readable media are disclosed for forming an image.

For instance, an exemplary image forming apparatus consistent with the invention comprises: an inputting device that inputs receives image information; an operation section that selects a cutting mark for reading by a cutting machine; an attaching device that attaches the selected cutting mark to an image of the received image information; and an image forming section that prints on a recording medium the image information and the attached cutting mark; wherein the attaching device attaches the selected cutting mark based on a comparison of a size of the recording medium and a size of the image.

In addition, another exemplary image forming apparatus consistent with the invention comprises: an input device that receives image information; an operation section that selects a cutting mark for reading by a cutting machine; an attaching device that attaches the selected cutting mark to an image of the received image information; and an image forming section that prints on a recording medium the image having the attached cutting mark; wherein the operation section adjusts the selected cutting mark such that a size of the image having the selected cutting mark will be less than a size of the recording medium.

An exemplary method for forming an image consistent with the invention comprises: receiving image information; selecting a cutting mark for reading by a cutting machine; attaching the selected cutting mark to an image of the received image information; and printing on a recording medium the image information and the attached cutting mark; wherein the attaching operation attaches the selected cutting mark based on a comparison of a size of the recording medium and a size of the image. The present invention also includes a recording medium which stores a computer readable program for performing the above method of forming an image. Another exemplary method for forming an image consistent with the invention, comprises: receiving image information; selecting a cutting mark for reading by a cutting machine; attaching the selected cutting mark to an image of the received image information; and printing on a recording medium the image having the attached cutting mark; wherein the cutting mark is selected such that a size of the image having the selected cutting mark will be less than a size of the recording medium. The present invention also includes a recording medium which stores a computer readable program for performing the above method of forming an image. It is to be understood that both the foregoing general description and the following detailed description are exemplary and explanatory only, and should not be considered restrictive of the scope of the invention, as described and claimed. Further, features and/or variations may be provided in addition to those set forth herein.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an exemplary functional block diagram showing the functional structure of the control section relating to an image forming apparatus consistent with the invention;

FIG. 2 is a diagram showing an exemplary system having a printer and relating to an image forming apparatus consistent with the invention;

FIG. 3 is an exemplary block diagram showing the structure of a printer consistent with the invention;

FIGS. 4(a) to 4(d) are diagrams showing exemplary register marks consistent with the invention;

FIG. 5 is a schematic diagram showing exemplary attaching operations of an attaching means consistent with the invention;

FIGS. 6 and 7 are a flow charts showing exemplary operations of a printer consistent with the invention;

FIG. 8 is a diagram showing an example of a display image area of an operation section consistent with the invention; and

FIG. 9 is a flow chart showing an alternative exemplary operation of a printer consistent with the invention.

### DETAILED DESCRIPTION

The preferred exemplary embodiment to practice an image forming apparatus consistent with the invention will be explained with reference to the attached drawings. The invention is not limited to this embodiment, which is intended to be only exemplary. The proper scope of the invention is defined by the appended claims.

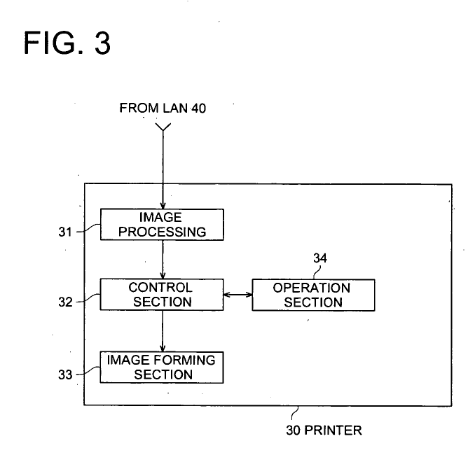

As shown in FIG. 2, the system preferably includes a PC 10, a scanner 20, a printer 30, a LAN 40 and a cutting machine 50.

The PC 10 is a personal computer which sends image information to the printer 30 through the LAN 40. The scanner 20 is an image information reading apparatus which sends image information to the printer 30 through the LAN 40. The printer 30 represents an image forming apparatus in which the image information output by the PC 10 or the scanner 20 is printed on a recording medium, such as a transfer sheet or a recording sheet. For example, the printer 30 is an electrophotographic printer or an ink jet printer that discharges ink drops.

The cutting machine 50 cuts the printed recording medium outputted from the printer 30 to a prescribed size. In this regard, the cutting machine 50 may read a position of the cutting mark (which is also referred to herein as a register mark) on the recording medium, and may then cut the recording medium based on this position information. For example, the recording medium is cut at cross-shaped register marks printed on four corners of the recording medium. Incidentally, a shape of the register mark to be used varies depending on a type of the cutting machine. Further, the recording medium outputted from the printer 30 may be subject to batch processing conducted by an operator of the cutting machine 50.

The LAN 40 is a communication cable through which image information and other data maybe transmitted and received among the PC 10, the scanner 20 and the printer 30, by the use, for example, of the CSMA/CD communication protocol.

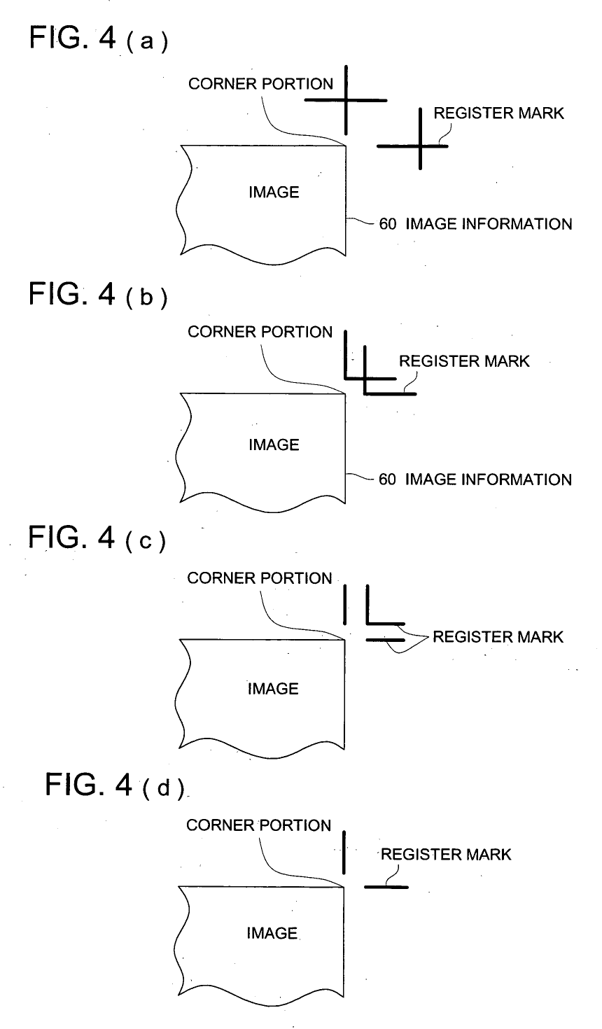

FIG. 3 is a functional block diagram showing exemplary functional structure of the printer 30. As shown in FIG. 3, the printer 30 includes image processing section 31, control section 32, image forming section 33 and operation section 34. The image processing section 31 includes an operation processor, an image memory and an interface, and it receives image information from the PC 10 or the scanner 20 through the interface. Processing section 31 may then conduct image processing such as □-correction or bitmap conversion on the image information.

The operation section 34 has an input device, such as a display portion of an LCD (Liquid Crystal Display), a touch panel or a ten key representing numeric keys. The input device may be used for setting various operation parameters for the printing process. Section 34 may also set the register mark, which will be explained in greater detail below.

The control section 32 controls the printer 30 and further includes a central processing unit (or CPU) and a memory. Section 32 may control the printer 30 based on one or more conditions established by the operation section 34. As will be explained in greater detail below, the control section 32 may compose image data of a register mark and the inputted image information by attaching the register mark to the image information.

The image forming section 33 receives a recording medium from a sheet-feeding tray and prints an image on the recording medium based on printing conditions output by the control section 32. Section 33 may then output the printed recording medium to an output tray.

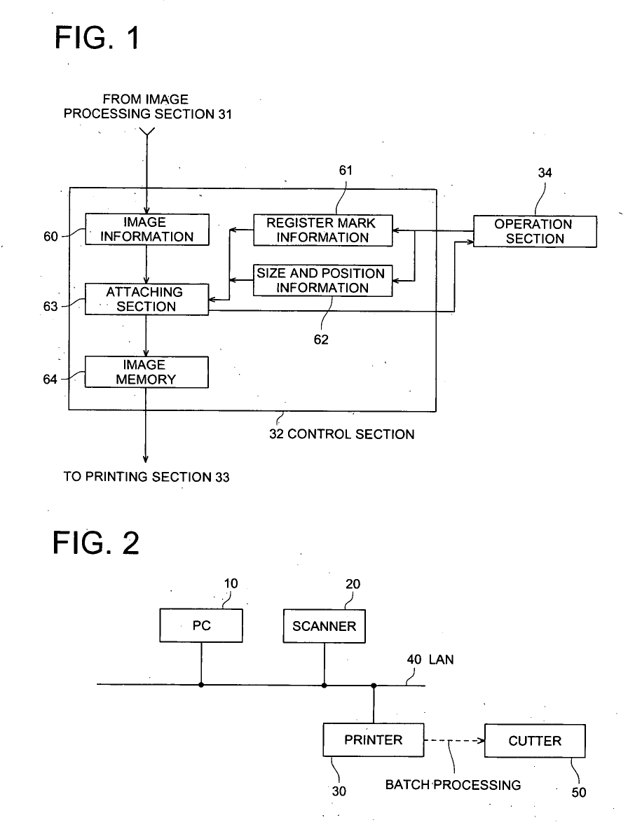

FIG. 1 is a functional block diagram of an exemplary control section 32 relating to the present embodiment. As shown in FIG. 1, the control section 32 may include an input for receiving image information 60, an input for receiving register mark information 61, an input for receiving size and/or position information 62 regarding the register mark, an attaching section 63 and an image memory 64. The image information 60 may be received from the PC 10 or the scanner 20.

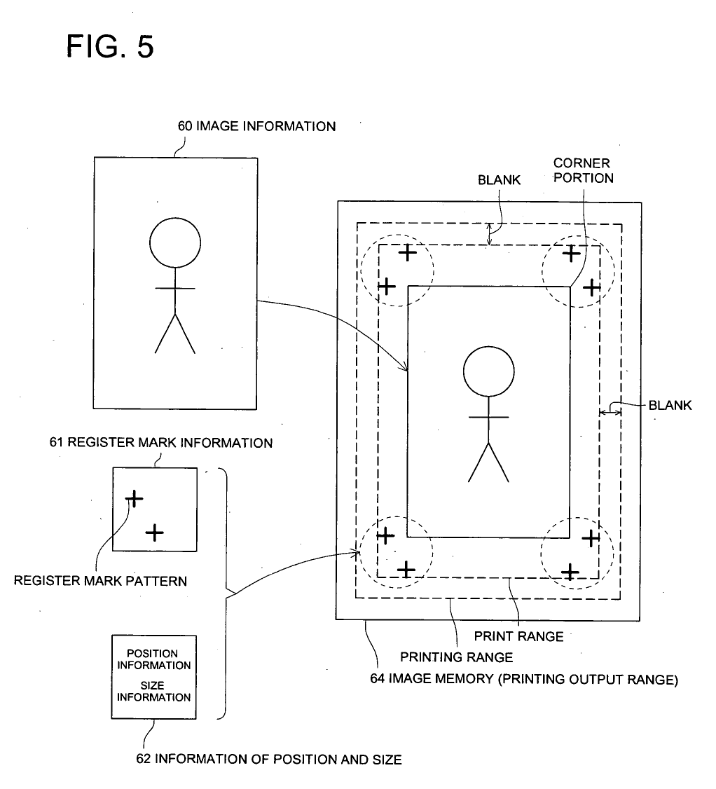

The register mark information 61 preferably includes multiple register mark patterns. Each pattern, for example, may be a version of a base register mark. For instance, FIGS. 4(a) to 4(d) show exemplary register mark patterns that may be stored in the register mark information 61. FIGS. 4(a)-4(d) each illustrate a register mark pattern that may be arranged at the four corners of an image forming a rectangular plane. FIG. 4(a) is an example having two cross-shaped register mark patterns oriented with respect to image information 60. In this example, the cutting machine may cut the recording medium along cutting lines passing through intersecting points of the crosses formed by the register marks and along the edges of the image information 60. The two register marks shown in FIG. 4(a) indicate cutting positions in two cutting directions, which may cross substantially at right angles at the corner of image information 60. One side of the corner portion where no cross-shaped mark exists may correspond to the corner position of the image information 60 and the other side of the corner portion may correspond to the corner portion of the recording medium which will be cut.

FIG. 4(b) shows an example where two L-shaped register marks are arranged. In this example, one side of the L-shaped mark is arranged to be along the edge portion of the image. The cutting machine may then cut the recording medium along a cutting line passing through the corner portion of the L-shaped register mark and along the edge portion of the image. In FIG. 4(b), the two register marks show the cutting positions on the cutting directions which substantially cross at right angles at the corner of image information 60.

FIG. 4(c) shows an example having an L-shaped register mark pattern and a center-missing L-shaped register mark pattern. In this example, a corner portion of the image information 60 is located at the center-missing portion of the center-missing L-shaped register mark. Cutting may then be conducted so that the cutting line passes through the corner portion of the L-shaped register mark along the edge portion of the image information 60. Thus, the corner portion of the L-shaped register mark and the corner portion of the cut recording medium coincide with each other. Each of the two sides of the L-shaped register mark shown in FIG. 4(c) correspond to the two cutting directions which substantially cross at right angles at the corner portion of the L-shaped register mark.

FIG. 4(d) shows an example having a center-missing L-shaped register mark. In this example, a corner portion of the image information 60 is located at the center-missing portion of the center-missing L-shaped letter. Further, the edge portions of two lines constituting the center-missing L-shaped mark correspond to the cutting position along the edge portion of image information 60.

As described above, the register mark information 61 may have register mark pattern information including cross-shaped, L-shaped, and center-missing L-shaped register marks as illustrated in FIGS. 4(a)-4(d).

Referring back to FIG. 1, the size and/or position information 62 may include information about a size of a register mark and/or of a position of the register mark with respect to the corner portion of the image information. Information of a register mark size is shown, for example, by: (1) a distance between a position of an intersection of a cross and a corner portion of the image information 60 in the case of a cross-shaped register mark, (2) a distance between a corner portion of an L-shaped register mark and a corner portion of the image information 60 in the case where one or more L-shaped register marks are arranged and (3) a distance between a center point of two sides constituting a center-missing L letter face each other and a corner portion of the image information 60 in the case of a center-missing L-shaped register mark.

Incidentally, in accordance with instructions output by operation section 34, a register mark may be selected from the register mark information 61, and may be transmitted to the attaching device 63. Further, in the same way, register mark size and/or position information 62 may be generated and transmitted to the attaching device 63 in accordance with instructions from operation section 34.

The image memory 64 is a memory that stores image information outputted from image forming section 33. Contents of this memory form printing output information which may be printed to agree with the size of a recording medium defined by the operation section 34. Therefore, the size of a printing output range may agree with the size of the memory 64 and the size of the recording medium. When contents of the memory 64 need to be preserved in the control section 32, the contents of the memory 64 may be subject to an image compression, and may then be subject to image decompression for printing.

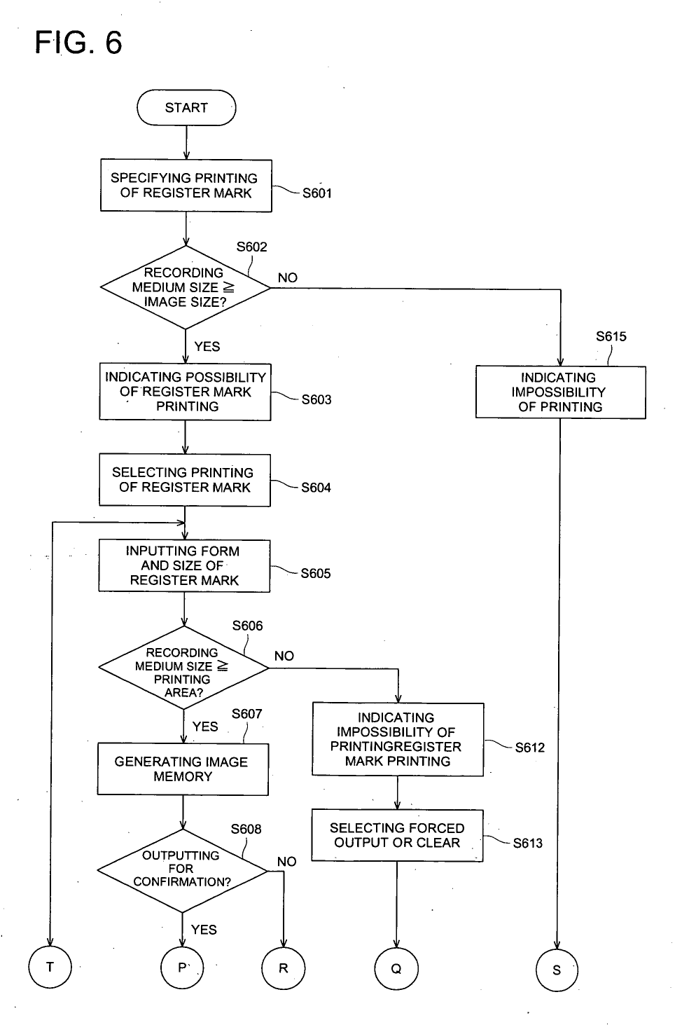

Attaching device 63 may attach a register mark on image information 60 based on the image information 60, register mark information 61 and register mark size and/or position information 62. Device 63 may then store the register mark in image memory 64. FIG. 5 is an exemplary diagram showing schematically how the register mark is attached by the attaching device 63. The image information 60 is arranged at a prescribed position within the center of the image memory 64 showing a printing output range. The register mark may also be associated with a size of the register mark and respective positions from four corners of the image, based on the register mark information 61 instructed by operation section 34 and on the register mark size and/or position information 62. The attaching device 63 may then arrange the register marks respectively at four corners existing on the image on the page memory 64 by optimizing a direction, a size and a position of each register mark.

In systems consistent with the invention, the attaching device-63 confirms a print range representing a minimum rectangular area surrounding the image information 60 and the register marks to be arranged in the image memory 64. The device 63 may then compute a printing range that has a blank region with a prescribed width around the periphery of the print range. After that, when the printing range exceeds the printing output range of the page memory 64 (which corresponds to a size of the recording medium), the attaching device 63 may discontinue writing data to the image memory 64, and transmit a warning signal to operation section 34. The operation section 34 may then receive the warning signal and display the warning on the display section.

The attaching device 63 may have a changing device that may change a width of a blank region based on the register mark size and/or position information 62. When the selected register mark is relatively large, the changing device may make the blank large, so that cutting may be conducted by cutting machine 50 properly. The specific relationship between a size of the register mark and a width of the blank region may be adjusted for the particular application based on routine experimentation.

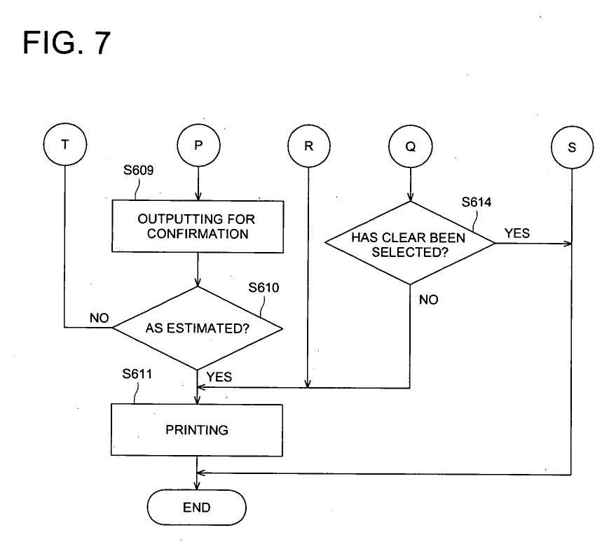

Next, operations of a printer 30 having a control section 32 will be explained with reference to FIG. 6 and FIG. 7. FIG. 6 and FIG. 7 are flow charts showing exemplary operations of printer 30. As shown in FIG. 6, an operator operates keys of operation section 34 to instruct printing of a register mark (step S601). The control section 32, in this case, then determines whether or not a size of a recording medium inputted from the operation section 34 is greater than or equal to an image size defined by, for example, image property information such as a header of image information 60 (step S602).

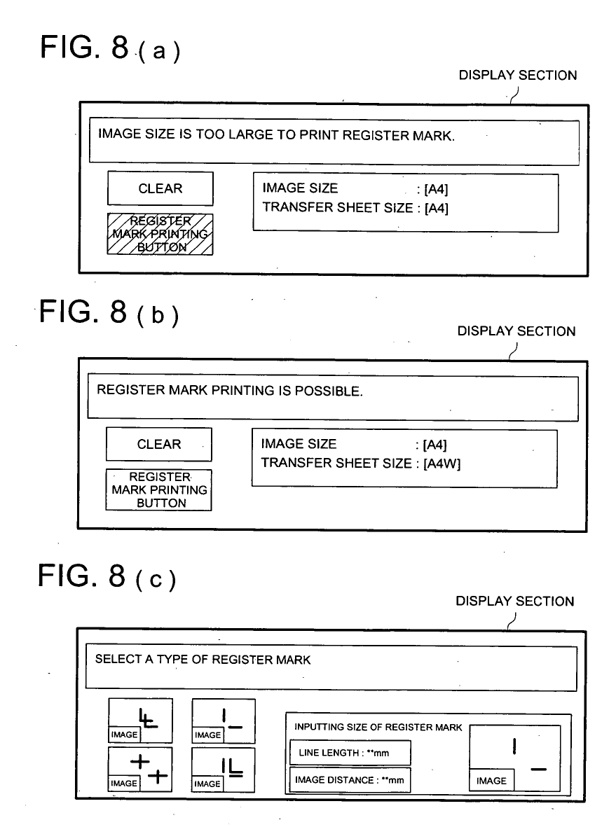

FIG. 8 shows an exemplary displayed image area to be displayed on a display section of the operation section 34. As shown in FIGS. 8(a) to 8(c), on the upper part of the displayed image area, there is displayed a comment showing the state of the control section 32 or actions of a user (e.g., “Image size is too large to print register mark”, “Register mark printing is possible”, or “Select a type of register mark”). On the lower left part, there may be provided a “clear” button which instructs removal of the image information 60, and a “register mark printing” button for selecting whether to print the register mark, or a selectable image areas for allowing an operator to select a particular register mark pattern. On the lower right part of the displayed image area, there may be displayed a recording medium size and an image size both of which may serve as a basis for determining whether the recording medium size is greater than or equal to an image size. The lower right portion may also display an input for the register mark size and an input for the position information.

Referring back to FIG. 6, when a size of a recording medium is smaller than an image size (“NO” in step S602), then the entire image information cannot be printed. Therefore, the control section 32 may discontinue writing to image memory 64 based on warning signals coming from the attaching device 63, and indicate the impossibility of printing on the display section (step S615) to end the processing.

In this regard, after the step S615 is carried out, the display to the effect that “image size is too large to print register mark” may appear on the comment column on the upper part of the image area, as shown in FIG. 8(a). Then, the register mark printing button at the lower left part of the display section may be made to be in a masked state, which shows that the register mark printing button is unusable. In addition, at the lower right part of the display section, that the system may display both of the image size and a size of a transfer sheet or recording medium (e.g., that the recording medium is A4 sized paper).

When a size of a recording medium is greater than or equal to the image size (“YES” in step S602), the control section 32 indicates “possibility of register mark printing” on the display section of the operation section 34 (step S603). FIG. 8(b) shows an example of the image area of the display section in this case. On the comment column on the upper part of the image area, there appears a display to the effect that “register mark printing is possible.” The register mark printing button on the lower left part is then displayed in a state showing that the register mark printing button is usable. In addition, at the lower right part of the display section, there appears the display to the effect that an image size is A4, and a transfer sheet size is A4W.

An operator may then select the register mark printing button (step S604), and inputs a register mark pattern showing a shape of a register mark, a size of the selected register mark pattern, and/or a position of the register mark through the operation section 34 (step S605).

FIG. 8(c) shows an example of a displayed image area in this case. In the comment column on the upper part of the image area, there is shown a display for selecting a type of a register mark. Then, at the lower left part, there may be shown register mark patterns which can be selected, while the lower right part may indicate an input image area showing a line length (representing a size of the register mark) and an image distance (indicating a distance from a corner section of the image to the register mark patterns). The line length and an image distance may be inputted by the use of a ten-key pad input terminal, or by any other type of input device known to those of ordinary skill in the art. In this way, a shape and a size of the register mark may be defined so that they may be read by cutting machine 50.

Next, attaching device 63 of the control section 32 may determine whether the recording medium size is equal to or greater than a printing range of image information 60 having the attached selected register marks (step S606). In this case (“YES” in step S606), the attaching device 63 may generate the image in image memory 64 (step s607) because all image information can be printed when the recording medium size is equal to or greater than the printing range.

The control section 32 may then determine, based on key operations conducted by an operator of the operation section 34, whether to confirm the output (step S608). If the output is to be confirmed (“YES” in step S608), the control section 32 confirms the output (step S609 in FIG. 7). In this regard, the operator confirms that the image information (with attached register marks) on the recording medium is as desired for printing (step S610). If so (“YES” in step S610), then the operator may conduct the actual printing (step S611) to end the processing. When the image information is, however, not as desired (“NO” in step S610), the operator may use input key operations of operation section 34 to return the processing to step S605, where a shape and a size of the register mark may be inputted again. These key operations for returning to step S605 may thus serve as a reset device.

Further, when no confirmation output is conducted (“NO” in step S608), the control section 32 moves the processing flow directly to step S611 to print the image and end the processing.

Referring back to step S606, when a recording medium size is smaller than a printing range of image information 60 having the attached register marks (“NO” in step S606), the control section 32 displays “impossibility of printing” on a display section (step S612). For example, by using a display image area such as that shown in FIG. 8(a), a display to the effect that the image size with an attached register mark is too large to print the register mark is shown in the comment column on the upper part of the image area.

The operator may then select whether to require the system to still print the image information 60 having the attached register mark or whether to clear the image information (step S613). When the operator selects the clear button(“YES” in step S614 in FIG. 7), the processing ends, while, when the clear button is not selected (“NO” in step S614 in FIG. 7), the system will still print the image information and register mark at step S611 to end the processing.

In the above exemplary embodiment, printer 30 uses attaching device 63 to attach register mark information 61 having a specified shape, size, and position to image information 60 for reading by a cutting machine 50. Further, according to the above exemplary embodiment, when a printing range of the image information 60 with the attached register mark exceeds a printing output range representing a size of image memory 64 or a recording medium size, a warning is given to discontinue printing, which prevents erroneous reading of the register mark by the cutting machine, reduces defective output of a recording medium from the cutting machine and improves printing efficiency.

Though the exemplary register marks described above are cross-shaped marks and L-shaped marks, the register marks may also be a point or any peculiar or identifying mark, provided that the register mark may be identified or read by cutting machine 50.

Further, though the attaching device 63 is described as part of the control section 32, the attaching device 63 may also be present on the image processing section 31 or on the image forming section 33.

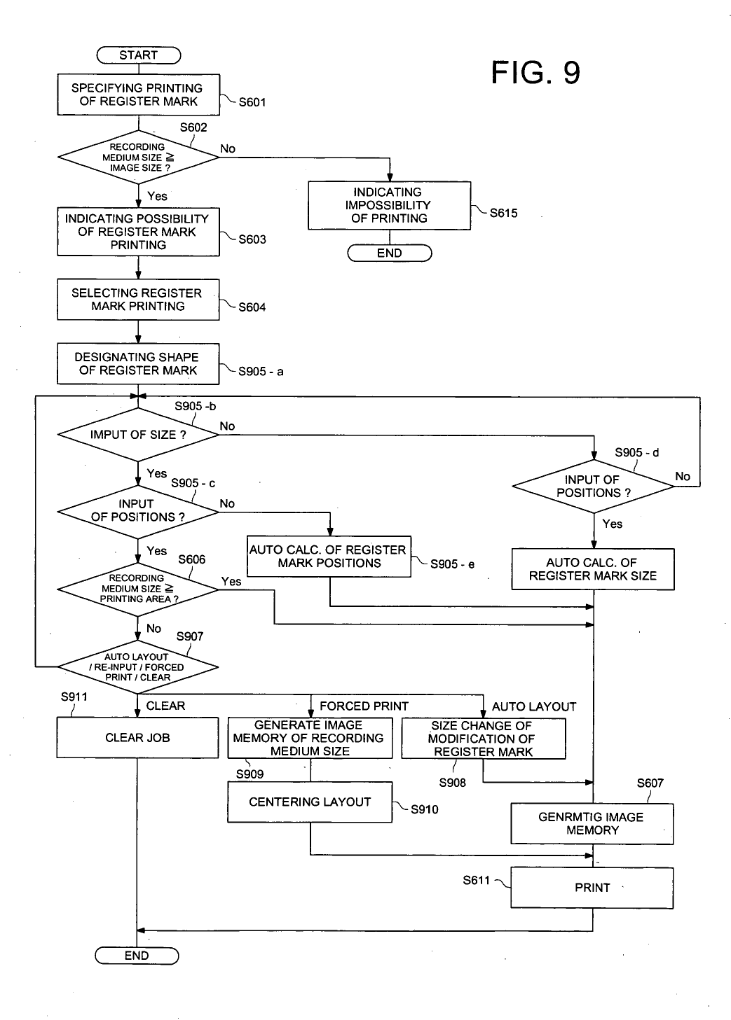

FIG. 9 is a flow chart illustrating another exemplary embodiment for forming an image consistent with the invention. The flow chart of FIG. 9 is similar to the flow charts of FIGS. 6 and 7, where like or similar processing steps have been labeled with the same reference numerals. For instance, processing steps S601 to S604 operate the same as described above with respect to FIG. 6. In particular, as indicated in FIG. 9, after the operator may select a register mark printing button (S604), and inputs a register pattern that represents a shape of the register mark (S905-a), and at least one of a size (S905-b) and a position (S905-c or S905-d) of the register mark. In a case where only one of the size and the position of the register mark is inputted (“NO” in step S905-c or “YES” in step S905-d), the other parameter may then be treated using an “auto” mode, such that the parameter is automatically calculated by reference to the image size, recording medium size, and the inputted information (steps S905-e or S905-f). For instance, in a case where the size of the register mark is inputted and register mark print is carried out at eight points on the recording medium, as shown in FIG. 5, the positions of the register marks may be automatically calculated by the following equation:
(marginal distance amount between image information 60 and register mark 61)=(width of recording medium−width of image information 60−width of register mark 61)/2.

Where the “marginal distance amount between image and register mark” is a negative value as a result of the above calculation, the system may prompt the operator to select between re-inputting the register mark size or designating the register mark position.

When the position or size of the register mark is automatically calculated, the values will be determined such that the size of the recording medium is equal to or greater than the size of the printing range of image information 60 having the attached register marks. Accordingly, the system will generate the image in image memory 64 (step S607) and then print the image (step S611) to end the process.

On the other hand, as shown in FIG. 9, when “YES” in step S905-c, the attaching device 63 of the control section 32 may determine whether the recording medium size is equal to or greater than a printing range of image information 60 having the attached selected register marks (step S606).

If “NO” in step S606, then, as shown in FIG. 9, the system may display selection keys of “auto layout,” “correction of input,” “forced output,” and/or “clear” to the operator (step S907). The system will then conduct an appropriate processes, such as those described above with respect to FIGS. 6 to 8, based on the selection by the operator. For instance, when “auto layout” is selected (step S908), priority is given to the register mark positions. The auto layout process may automatically attempt to fit the whole image area into the recording medium size by, for example, scaling down the register mark, or shortening the length of the line that over-protrudes with respect to each cross-point of cross shaped or L shaped register marks. On the other hand, when the whole area cannot be included in the recording media size by simply modifying the register mark size, the register mark positions may also be modified.

When “correction of input” is selected (not shown in FIG. 9), the process may return, for example, to step S604 of FIG. 6 and proceed according to the processing of FIG. 6. When “forced output” is selected (step S909), the print output may be carried out with cutting top and bottom portions or right and left portions of the resultant image in order that the inputted image information is laid out at the center position of the recording medium (step s910). If “clear” is selected (step S911), the target image formation job may be cancelled.

The foregoing has described principles, preferred embodiments and modes of operation of the invention. However, the invention should not be construed as being limited to the particular embodiments discussed. Thus, the above-described embodiments should be regarded as illustrative rather than restrictive, and it should be appreciated that variations may be made in those embodiments by workers skilled in the art without departing from the scope of the invention as defined by the following claims and equivalents thereof.

1. An image forming apparatus comprising:
an inputting section that receives image information;
an operation section that adopts a cutting mark for being read by a cutting machine;
an image forming section that prints on a recording medium the image information and the cutting mark; and
a control section that, prior to the print operation by the image forming section, determines whether a printing range of the image information and the cutting mark can be included in the recording medium or not.

2. The image forming apparatus of claim 1, wherein the operation section selects one of a plurality of kinds of cutting marks, and thereby adopts the selected one kind of the cutting marks.

3. The image forming apparatus of claim 1, wherein the plurality of kinds of cutting marks include an L-shaped mark and a cross-shaped cutting mark.

4. The image forming apparatus of claim 1, wherein the printing range is a range to which a blank periphery region is given to the image information and the cutting mark.

5. The image forming apparatus of claim 1, wherein the operation section comprises a display to which a warning information is displayed when the printing range exceeds a size of the recording medium.

6. The image forming apparatus of claim 1, wherein the operation section comprises a first setting section for setting whether printing of the image information and the cutting mark should be carried out when the printing range exceeds a size of the recording medium.

7. The image forming apparatus of claim 1, wherein the operation section comprises a second setting section for setting a size of the cutting mark.

8. The image forming apparatus of claim 4, wherein the operation section comprises a second setting section for setting a size of the cutting mark, and wherein a size of the blank periphery region is adjusted in accordance with the setting by the second setting section.

9. The image forming apparatus of claim 1, wherein the operation section adopts the cutting mark again after confirming a certain number of printing of the image information and the cutting mark by the image forming section.

10. The image forming apparatus of claim 1, wherein the operation section comprises an adjuster for adjusting at least one of a shape, a size, and a position of the cutting mark when the printing range exceeds a size of the recording medium.

11. An image forming system comprising:
an inputting section that receives image information;
an operation section that adopts a cutting mark for being read by a cutting machine;
an image forming section that prints on a recording medium the image information and the cutting mark; and
a control section that, prior to the print operation by the image forming section, determines whether a printing range of the image information and the cutting mark can be included in the recording medium or not.

12. The image forming system of claim 11, wherein the operation section selects one of a plurality of kinds of cutting marks, and thereby adopts the selected one kind of the cutting marks.

13. The image forming system of claim 11, wherein the plurality of kinds of cutting marks include an L-shaped mark and a cross-shaped cutting mark.

14. The image forming system of claim 11, wherein the printing range is a range to which a blank periphery region is given to the image information and the cutting mark.

15. The image forming system of claim 11, wherein the operation section comprises a display to which a warning information is displayed when the printing range exceeds a size of the recording medium.

16. The image forming system of claim 11, wherein the operation section comprises a first setting section for setting whether printing of the image information and the cutting mark should be carried out when the printing range exceeds a size of the recording medium.

17. The image forming system of claim 11, wherein the operation section comprises a second setting section for setting a size of the cutting mark.

18. The image forming system of claim 14, wherein the operation section comprises a second setting section for setting a size of the cutting mark, and wherein a size of the blank periphery region is adjusted in accordance with the setting by the second setting section.

19. The image forming system of claim 11, wherein the operation section adopts the cutting mark again after a certain number of printing of the image information and the cutting mark by the image forming section.

20. The image forming system of claim 11, wherein the operation section comprises an adjuster for adjusting at least one of a shape, a size, and a position of the cutting mark when the printing range exceeds a size of the recording medium.

21. An image forming system comprising:
an input device that receives image information;
an operation section that adopts a cutting mark for being read by a cutting machine;
an image forming section that prints on a recording medium the image information and the cutting mark; and
a controller that, prior to the print operation by the image forming section, adjusts the cutting mark such that a size of a printing range of the image information and the cutting mark will not exceed a size of the recording medium.

22. The image forming system of claim 21, wherein the operation section adjusts a shape of the cutting mark such that the size of the printing range will not exceed the size of the recording medium.

23. The image forming system of claim 21, wherein the operation section adjusts a position of the cutting mark such that the size of the printing range will not exceed the size of the recording medium.

24. The image forming system of claim 21, wherein the operation section adjusts a size of the cutting mark such that the size of the printing range will not exceed the size of the recording medium.

25. The apparatus of claim 21, wherein the operation section adjusts the selected cutting mark by selecting a different cutting mark.

26. The apparatus of claim 21, wherein the operation section selects a cutting mark from a plurality of kinds of cutting marks including an L-shaped cutting mark and a cross-shaped cutting mark.

27. The image forming apparatus of claim 21, wherein the printing range is a range to which a blank periphery region is given to the image information and the cutting mark.

28. An image forming method comprising the steps of:
receiving image information;
adopting a cutting mark for being read by a cutting machine;
printing on a recording medium the image information and the cutting mark; and
determining, prior to the printing step, whether a printing range of the image information and the cutting mark can be included in the recording medium or not.

29. A computer program stored in a computer readable medium, the computer program causing a computer to carry out the image forming method of claim 28.

30. An image forming method comprising the steps of:
receiving image information;
adopting a cutting mark for being read by a cutting machine;
printing on a recording medium the image information and the cutting mark; and
adjusting, prior to the printing step, the cutting mark such that a size of a printing range of the image information and the cutting mark will not exceed a size of the recording medium.

31. A computer program stored in a computer readable medium, the computer program causing a computer to carry out the image forming method of claim 30.
